(19) United States
(12) Patent Application Publication
(10) Pub. No.: US 2022/0380661 A1
(43) Pub. Date: Dec. 1, 2022

(54) QUATERNIZED ALKOXYLATED POLYMER SURFACTANT

(71) Applicant: ARC PRODUCTS, INC., Dallas, TX (US)

(72) Inventors: Michael HEATH, Dallas, TX (US); Bobby VITEAUX, Dallas, TX (US)

(73) Assignee: ARC PRODUCTS, INC., Dallas, TX (US)

(21) Appl. No.: 17/815,648

(22) Filed: Jul. 28, 2022

Related U.S. Application Data
(63) Continuation-in-part of application No. 16/763,441, filed on May 12, 2020.
(60) Provisional application No. 62/611,627, filed on Dec. 29, 2017.

(51) Int. Cl. C09K 8/60

(52) U.S. Cl. CPC C09K 8/604

(57) ABSTRACT

A quaternized alkoxylated polyethylene amine can be used in a variety of industries, including the oil and gas servicing industry, as a laundry detergent, the personal care industry, as an industrial cleaner, paint, or coating, and mining operations industry. A treatment fluid comprises: a base fluid; and the surfactant. A method of treating a subterranean formation comprises introducing the treatment fluid into a well, wherein the well penetrates the subterranean formation.

### TECHNICAL FIELD

Surfactants can be used in a variety of fluids in the oil and gas servicing industry. The surfactants can be cationic surfactants and impart desirable properties to the fluids.

### DETAILED DESCRIPTION

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located at depths ranging from a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

As used herein, a “fluid” is a substance having a continuous phase that tends to flow and to conform to the outline of its container when the substance is tested at a temperature of 71° F. (22° C.) and a pressure of 1 atmosphere (atm) (0.1 megapascals (MPa). Because of the nature and distribution of their natural hydrocarbon components, some reservoir “fluids” require temperatures higher than 71V to flow and to conform to the outlines of their containers. In such cases, testing and field treatments are often done at those higher temperatures. A fluid can be a liquid or gas. A homogenous fluid has only one phase, whereas a heterogeneous fluid has more than one distinct phase. A heterogeneous fluid can be: a slurry, which includes an external liquid phase and undissolved solid particles as the internal phase; an emulsion, which includes an external liquid phase and at least one internal phase of immiscible liquid droplets; a foam, which includes an external liquid phase and a gas as the internal phase; or a mist, which includes an external gas phase and liquid droplets as the internal phase. In some cases, heterogeneous reservoir fluids can be complex combinations of the above that may change with changes in variables such as temperature, pressure, and shear.

A well can include, without limitation, an oil, gas, or water production well, or an injection well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include but are not limited to the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During wellbore operations, it is common to introduce a treatment fluid into the well. It is also common to introduce a treatment fluid into produced reservoir fluids above ground. A variety of treatment fluids are used in a variety of wellbore operations. Examples of common treatment fluids include, but are not limited to, drilling fluids, spacer fluids, cement compositions, completion fluids, work-over fluids, clean-up fluids, crude oil production, stimulation fluids, and storage and transportation of fluids. As used herein, a “treatment fluid” is a fluid designed and prepared to resolve a specific condition of a well or subterranean formation, such as for stimulation, isolation, gravel packing, or control of gas or water coning when used in the oil and gas servicing industry. The term “treatment fluid” refers to the specific composition of the fluid as it is being introduced into a well. The word “treatment” in the term “treatment fluid” does not necessarily imply any particular action by the fluid. When used in other industries, as used herein, the term “treatment fluid” means a fluid designed to achieve a desired result and provide specific properties, such as cleaning clothes, hair, skin, and other surfaces, and paint formulations. By way of example, some desired results for a paint formulation can include defoaming, better dispersion of pigments, better adhesion to surfaces, improved leveling and flow properties, among others.

Hydraulic fracturing, sometimes simply referred to as “fracturing” or “fracing,” is a common stimulation treatment. A treatment fluid adapted for this purpose is sometimes referred to as a fracturing fluid or “frac fluid.” The fracturing fluid is pumped at a sufficiently high flow rate and high pressure into the wellbore and into the subterranean formation to create a fracture in the subterranean formation. As used herein, “creating a fracture” means making a new fracture in the formation or enlarging a pre-existing fracture in the formation. The fracturing fluid may be pumped down into the wellbore at high rates and pressures, for example, at a flow rate in excess of 100 barrels per minute (3,150 U.S. gallons per minute) at a pressure in excess of 5,000 pounds per square inch (“psi”) (35 megapascals “MPa”).

Additionally, some treatment fluids are used in above ground operations to bring about desired effects, such as dehydration, desalination, and clean phase separation of undesirable components. The treatment fluids generally contain a base fluid and one or more additives. As used herein, the term “base fluid” means the liquid that is in the greatest concentration and is the solvent of a solution or the continuous phase of a heterogeneous fluid.

Additional applications of treatment fluids include, but are not limited to, augmenting the dehydration and clean separation of oil and water-phases indigenous to produced hydrocarbon liquids, to help break and prevent formation of emulsions during subterranean flow, to impart differential wetting of subterranean surfaces to facilitate concurrent flow of liquids, to disperse problematic colloidal solids and heavy hydrocarbons, to augment the inhibition of water imbibition, hydration and swelling of water-sensitive subterranean rock formations, and to facilitate the removal of undesirable materials from surfaces. Other additional applications of a treatment fluid include detergents (e.g., for clothes), personal care formulations (e.g., hair shampoos and conditioners, hand soaps), industrial cleaners, paints and coatings, and mining operations. There may be other industrial applications not specifically mentioned that the disclosed surfactant and treatment fluid containing the surfactant may be used in.

A surfactant is one type of additive that can be included in a treatment fluid. The surfactant can impart desirable properties to the treatment fluid. A surfactant is an amphiphilic molecule comprising a hydrophobic tail group and a hydrophilic head group. It is to be understood that reference to “tail groups” and “head groups” are for illustrative purposes only and do not necessarily mean that there is a tail group at one end of the molecule and a head group at the other end of the molecule because a tail or head group can also be part of the internal structure of the surfactant molecule. Moreover, a surfactant can also have multiple tail and/or head groups located at various locations within the molecule structure. The hydrophilic head can be charged. A cationic surfactant includes a positively charged head. An anionic surfactant includes a negatively charged head. A zwitterionic surfactant includes both a positively- and negatively charged head. A surfactant with no charge is called a non-ionic surfactant. The reaction sequence of products in addition to the reactants used affects whether distinct tail or head groups are formed. By way of example, a reaction of tetraethylene pentamine (TEPA) with only ethylene oxide (EO) converts the hydrophilic primary and secondary amines of the TEPA into hydrophilic tertiary amines and produces compounds that continue to be very hydrophilic, having more than one hydrophilic head group, but no distinct hydrophobic tail group. A compound that does not contain a distinct hydrophobic region is not considered to be a surfactant, but rather can be considered a dispersant. On the other hand, the reaction of tetraethylene pentamine (TEPA) with only propylene oxide (PO) converts the hydrophilic primary and secondary amines of the TEPA into hydrophobic tertiary amines and produces compounds having more than one hydrophobic region, but no distinct hydrophilic region. This result occurs because complete conversion of the primary and secondary amine groups of TEPA into all tertiary amines with PO renders the TEPA region hydrophobic. Subsequent quaternization converts the hydrophobic head portion of the TEPA into a hydrophile, while retaining the hydrophobic tail portion.

A surfactant can lower the interfacial tension between two liquids or between a solid and a liquid. As such, a surfactant can be used to reduce the surface tension between the solids of a subterranean formation and the treatment fluid in order for the treatment fluid to penetrate farther into the formation. A surfactant can also be used to change the wettability of the surface of solids of a formation. Wettability means the preference of a surface to be in contact with one liquid or gas rather than another. Accordingly, “oil-wet” means the preference of a surface to be in contact with an oil phase or gas phase rather than a water phase, and “water-wet” means the preference of a surface to be in contact with a water phase rather than an oil phase or gas phase. A surfactant can be used to change the wettability of the surface of the solids from being water-wet to being oil-wet or vice versa. In some cases, surfactants adsorbed onto a surface can equalize or even lessen the affinity of both oil and water to that surface. Such wettability changes can help promote production of oil and/or gas from a reservoir. The reaction sequence in addition to the reactants used effects how a surfactant or dispersant changes the wettability of solids. By way of example, a reaction of a polyethylene amine with only ethylene oxide will form a dispersant that makes solids water wet. By contrast, the reaction of a polyethylene amine with only propylene oxide will form a surfactant the makes solids oil wet. A reaction of a polyethylene amine with propylene oxide and then ethylene oxide can equalize the wettability and lessen the affinity of both water and oil onto solids. Accordingly, a quaternized alkoxylated polyethylene amine surfactant formed with only propylene oxide or with both propylene oxide and then ethylene oxide will have a completely different wettability compared to a dispersant formed with only ethylene oxide due to the drastically different hydrophobic/hydrophilic portions formed during the reaction.

If a surfactant is in a sufficient concentration in a solution, then the surfactant molecules can form micelles. A “micelle” is an aggregate of surfactant molecules dispersed in a solution. A surfactant in an aqueous solution can form micelles with the hydrophilic heads in contact with the surrounding aqueous solvent, sequestering the hydrophobic tails in the micelle center. The surfactant must be in a sufficient concentration to form micelles, known as the critical micelle concentration (CMC). The critical micelle concentration is the concentration of surfactant above which micelles are spontaneously formed. Some surfactant functions, such as those that involve lowering surface tension, are optimized by the surfactant being at or above its CMC in the bulk phase; whereas other interfacial surfactant functions, such as those involved in emulsion breaking or prevention, are optimized at concentrations well below the CMC.

There is an ongoing industry-wide search for new surfactants that can be used more effectively in treatment fluids.

It has been discovered that a quaternized alkoxylated polyethylene amine (PEA) polymer cationic surfactant can be used in treatment fluids. One of the advantages to the new surfactant is improved properties to the treatment fluid. The treatment fluid can be used in the following industries by way of non-limiting examples: the oil and gas servicing industry, detergents (e.g., for clothes), personal care formulations (e.g., hair shampoos and conditioners, and hand soaps), industrial cleaners, paints and coatings, and mining operations.

A polymer is a large molecule composed of repeating units, typically connected by covalent chemical bonds. A polymer is formed from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain functional groups connected to the backbone at various locations along the backbone. Polymer nomenclature is generally based upon the type of monomer residues comprising the polymer. A polymer formed from one type of monomer residue is called a homopolymer. A copolymer is formed from two or more different types of monomer residues. The number of repeating units of a polymer is referred to as the chain length of the polymer. The number of repeating units of a polymer can range from approximately 11 to greater than 10,000. In a copolymer, the repeating units from each of the monomer residues can be arranged in various manners along the polymer chain. For example, the repeating units can be random, alternating, periodic, or block. The conditions of the polymerization reaction can be adjusted to help control the average number of repeating units (the average chain length) of the polymer.

A polymer has an average molecular weight, which is directly related to the average chain length of the polymer. The average molecular weight of a polymer has an impact on some of the physical characteristics of a polymer, for example, its solubility and its dispersibility. For a copolymer, each of the monomers will be repeated a certain number of times (number of repeating units). The average molecular weight (M_{w}) for a copolymer can be expressed as follows:

M_{w}=ΣwₓMₓ

where wₓ is the weight fraction of molecules whose weight is Mₓ.

According to an embodiment, a treatment fluid comprises: a base fluid; and a surfactant, wherein the surfactant is a quaternized alkoxylated polyethylene amine.

According to another embodiment, a method of treating a portion of a subterranean formation comprises: introducing the treatment fluid into a well, wherein the well penetrates the subterranean formation.

The discussion of preferred embodiments regarding the treatment fluid or any ingredient in the treatment fluid, is intended to apply to the composition embodiments and the method embodiments. Any reference to the unit “gallons” means U.S. gallons.

The treatment fluid can be a homogenous fluid or a heterogeneous fluid. The treatment fluid can be a slurry, emulsion, or invert emulsion. The treatment fluid includes a base fluid. The base fluid can include water. The water can be selected from the group consisting of freshwater, brackish water, saltwater, and any combination thereof. The base fluid can further include a water-soluble salt. Preferably, the salt is selected from the group consisting of sodium chloride, calcium chloride, calcium bromide, potassium chloride, potassium bromide, potassium formate, magnesium chloride, sodium bromide, cesium formate, cesium acetate, and any combination thereof.

The base fluid can also include a hydrocarbon liquid. As used herein, the phrase “hydrocarbon liquid” means a pure hydrocarbon liquid or a hydrocarbon-containing liquid. The hydrocarbon liquid can be selected from the group consisting of: a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Crude oil can be separated into fractional distillates based on the boiling point of the fractions in the crude oil. An example of a suitable fractional distillate of crude oil is diesel oil. The saturated hydrocarbon can be an alkane or paraffin. Preferably, the saturated hydrocarbon is an alkane. The paraffin can be an isoalkane (isoparaffin), a linear alkane (paraffin), or a cyclic alkane (cycloparaffin). The unsaturated hydrocarbon can be an alkene, alkyne, or aromatic. The alkene can be an isoalkene, linear alkene, or cyclic alkene. The linear alkene can be a linear alpha olefin or an internal olefin.

The treatment fluid can be a variety of different types of fluids and be used in a variety of different types of oilfield operations, such as at a wellsite, in transportation and storage of liquid hydrocarbons, and in refineries. Non-limiting examples of uses of the surfactant additive include in a wellbore fluid, as a non-emulsifier, as an emulsion breaker or de-emulsifier, wetting-out and dispersing asphaltenes in crude oils, de-salting of refinery fluids (i.e., washing residual salts out of the crude oil with fresh water before refining), as a macro-emulsifier or micro-emulsifier, and adsorbing onto subterranean rock surfaces to positively impact the out-flow of indigenous fluids and stabilize those subterranean surfaces by discouraging imbibition of damaging fresher waters.

The treatment fluid includes the surfactant. The surfactant can be a cationic surfactant. The surfactant can be a quaternized alkoxylated polyethylene amine (PEA) polymer. Alkoxylation is a chemical reaction that involves the addition of an epoxide to another compound. It is to be understood that all compounds that are ethoxylated are also considered to be alkoxylated; however, not all alkoxylated compounds are also inherently ethoxylated. According to certain embodiments, the alkoxylated surfactant is not considered to be ethoxylated. Additionally, according to certain embodiments, the nature of the alkoxylating agent(s), as well as the degree(s) and sequence(s) of alkoxylation can be selected to provide desirable properties to the surfactant.

According to certain embodiments, the PEA polymer is diethylene triamine (DETA), triethylene tetramine (TETA) or tetraethylene pentamine (TEPA). The molecular weight of the PEA polymer can vary. The PEA polymer can have a molecular weight greater than about 100. The PEA polymer can also have a molecular weight in the range of about 100 to about 1,000,000, preferably about 100 to about 100,000, more preferably about 100 to about 10,000. The PEA polymer can also have a molecular weight such that the surfactant is soluble or dispersible in the base fluid. As used herein, the term “soluble” means that at least one part of the substance dissolves in 10,000 parts of a liquid.

The surfactant is quaternized. A quaternary compound is a cation consisting of a central positively charged atom with four substituents, especially organic (alkyl and aryl) groups, discounting hydrogen atoms. The number of nitrogen atoms of the surfactant that are quaternized can vary. By way of example, the number of nitrogen atoms that are quaternized can range from 1 to 5. It is to be understood that the compound that is quaternized can include from 3 to 5 nitrogen atoms. An example of a compound including: 3 nitrogen atoms is diethylene triamine (DETA); 4 nitrogen atoms is triethylene tetramine (TETA); and 5 nitrogen atoms is tetraethylene pentamine (TEPA). It is to also be understood that even if the compound includes 5 nitrogen atoms, that not all of the nitrogen atoms need to be quaternized. The degree of quaternization can be controlled and selected based on the desired properties of the surfactant.

The agents used to quaternize the surfactant can vary. Depending upon the surfactant properties desired in a particular treatment fluid, the agent(s) used to quaternize the surfactant can vary, which affects (1) which hydrocarbon group becomes the fourth to attach to the nitrogen(s) in quaternization and 2) what the surfactant counter-anion(s) will be. Non-limiting variations include methyl-, ethyl-, or benzyl-quaternization agents with Cl⁻, Br⁻, or SO₄⁼ counter-anion(s).

The following is but one, non-limiting, example of a surfactant according to certain embodiments.

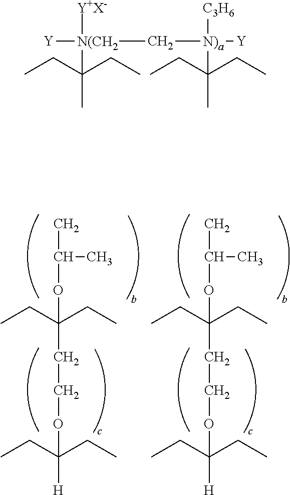

where Y=methyl, ethyl, benzyl, etc.; X=Cl⁻, Br⁻, I⁻, or ½SO₄⁼; a=2-4; b=1-100; and c=0-40.

A process for producing the quaternized alkoxylated polyethylene amine can include undertaking only alkoxylation of the polyethylene amine in a first step. Thus, a process for preparing a water-soluble alkoxylated polyethylene amine is reacting reactants consisting essentially of the polyethylene amine first with propylene oxide and then with ethylene oxide. In a second step, the alkoxylated polyethylene amine is reacted with a quaternization agent to form the quaternized alkoxylated polyethylene amine. It is to be understood that in the first step of producing the alkoxylated polyethylene amine, that the reactants consist essentially of the polyethylene amine, the propylene oxide, and the ethylene oxide, wherein minor amounts of other compounds, such as a catalyst, can be included but no other major reactants are included. In other words, the polyethylene amine is not reacted with any other reactants besides propylene oxide and ethylene oxide, wherein the polyethylene amine is reacted first with the propylene oxide and then secondly reacted with the ethylene oxide, to form the alkoxylated polyethylene amine with optional catalysts or solvents used in the reaction.

In the first step, a first reaction is carried out in which an anhydrous polyethylene amine (PEA) is reacted only with the propylene oxide (PO) in a liquid or gas form carried out in the absence of a catalyst at a temperature in the range from about 70 to about 200° C., or from about 80 to about 160° C., under a pressure of up to about 10 bar. In the first reaction, just enough PO is added in order to convert all of the primary and secondary amines into tertiary amines. By way of example, 1 mol of PO can be added for every secondary amine functional group of the PEA and 2 mols of PO can be added for every primary amine functional group of the PEA Accordingly, for the case of tetraethylenepentamine (TEPA), which includes 3 secondary amines and 2 primary amines, a total of 7 mol of PO can be added for complete conversion. The exact amount of PO needed in the first reaction can also be calculated based on weight and molar mass. For example, in the case of TEPA as the polyethylene amine having a molar mass of 189.3 grams per mol (g/mol), and PO having a molar mass of 58.1 g/mol, for every 189.3 grams of TEPA used, 406.7 grams of PO can be added for the first reaction. A slight excess amount of PO can also be added in the first reaction to drive the reaction to fully convert all of the amines into tertiary amines. Conversion all of the amines of the PEA to their tertiary forms will form a hydrophobe with hydroxyl groups formed from the conversion. Accordingly, the PO is initially only reacting with the amines until all of the amines have been converted to tertiary amines before reacting with hydroxyl groups of PO that has already been added. Analysis can be performed to ensure that all of the amines have been converted to tertiary amines before continuing the subsequent reactions.

In the first step, after all of the amines have been converted into tertiary form, then a second reaction is initiated with the addition of an alkaline catalyst and additional PO in order to enable the PO to react with the hydroxyl groups of the PO from first reaction. The alkaline catalyst reacts with the hydroxyl groups to form alkoxide ions (O⁻), which allows the additional PO to be added. The product from the second reaction becomes more hydrophobic due to the addition of the additional PO and formation of alkoxide ions. The resulting product includes each tertiary amine from the PEA centrally located within a highly branched polymer network comprising polypropylene glycol chains radiating out from the tertiary amines. In the case of tetraethylene pentamine (TEPA), a total of 7 polypropylene glycol chains will be present for every mol of TEPA.

After the second reaction, a third reaction is then carried out in which the product from the second reaction is reacted with ethylene oxide (EO). The EO reacts with the tail ends of the polypropylene glycol chains to form hydrophilic tails that form the surfactant. Additional alkaline catalyst can be added if needed during the third reaction.

Examples of suitable catalysts are strong base anhydrous catalysts such as alkali metals (e.g., potassium or sodium); alkaline earth metal hydroxides, such as sodium hydroxide, potassium hydroxide, and calcium hydroxide; alkali metal alkoxides, in particular sodium and potassium C—C-alkoxides, such as sodium methoxide, sodium ethoxide and potassium tert-butoxide. According to any of the embodiments, the strong base anhydrous catalyst is selected from potassium hydroxide or sodium hydroxide. The basic catalyst can be in a concentration in the range from about 0.01 to about 1% by weight of the reactants of the first step.

The first, second, and/or third reactions to form the alkoxylated polyethylene amine can be carried out in an anhydrous solvent. Suitable solvents include, but are not limited to, toluene, xylene, or aromatic naphtha.

According to any of the embodiments, the quaternized alkoxylated polyethylene amine is produced by the following reaction sequence.
tetraethylene pentamine (TEPA)+propylene oxide (PO)→hydrophobic polytertiary amine+additional PO+catalyst→highly branched polypropylene glycol polymer+ethylene oxide (EO)→TEPA alkoxylate+methyl chloride→quaternized TEPA alkoxylate.

The reaction sequence shown above affects the resulting properties of the quaternized alkoxylated polyethylene amine. The resulting properties can be both neat fluidity and water solubility. By way of example, the reaction of a polyethylene amine with propylene oxide first and then subsequently ethylene oxide produces a compound that possesses a hydrophobic head group, a hydrophobic middle portion, and a hydrophilic tail portion. Subsequent quaternization with the quaternization agent converts the hydrophobic head portion of the polyethylene amine into a hydrophile as evidenced by an increase in water solubility compared to its un-quaternized precursor. The resulting properties will also affect the wettability of the quaternized alkoxylated polyethylene amine. By way of example, it was unexpectedly discovered that the sequential reaction of the polyethylene amine with propylene oxide and then ethylene oxide can equalize surface wettability and actually lessen the affinity of both water and oil onto certain solids.

The concentration of the TEPA can be in the range from about 0.2% to about 10%; the concentration of the propylene oxide in the range of about 30% to about 97%; the concentration of the ethylene oxide in the range of about 3% to about 50% by weight of the compounds reacting to form the TEPA alkoxylate. The TEPA alkoxylate can be represented by the following structure:

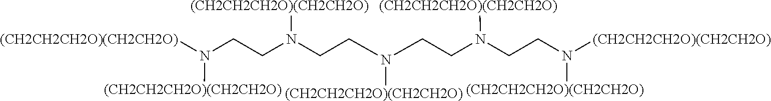

The alkoxylated PEA polymer can then be reacted with a quaternization agent containing methyl, ethyl, or benzyl to quaternize the nitrogen atoms in the polymer. By way of but one non-limiting example, the alkoxylated PEA polymer can be reacted with methyl chloride. As discussed above, the reaction conditions can be adjusted and controlled to provide a desired amount of quaternization. The alkoxylated PEA polymer can be reacted at a concentration in the range of about 95% to about 99.9% by weight with the quaternization agent in a concentration of about 0.25% to about 5% by weight. A higher concentration of the quaternization agent can cause more of the nitrogen atoms of the alkoxylated PEA polymer to become quaternized. A fully quaternized TEPA alkoxylate that has been reacted with methyl chloride can be represented by the following chemical structure:

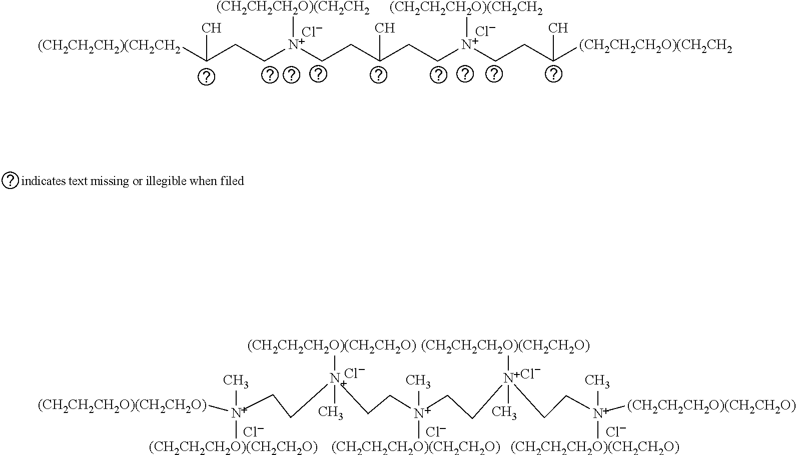

The surfactant can be included in the base fluid in a concentration in the range of about 0.0001% to about 40% by weight of the base fluid.

The treatment fluid can also contain various other additives and have a variety of desirable properties based on the type of treatment fluid and industry uses. The other additives can be selected based on the type of treatment fluid. By way of one example, if the treatment fluid is a frac fluid, then the fluid can also include proppant, a viscosifier, etc. Other additives can include cement, proppant, a viscosifier, a suspending agent, a weighting agent, a friction reducer, a filler, a fluid loss additive, a set retarder, a strength-retrogression additive, a light-weight additive, a defoaming agent, a mechanical property enhancing additive, a lost-circulation material, a filtration-control additive, a thixotropic additive, and combinations thereof. The other additives can also be selected based on the type of industry the treatment fluid is used in. One of ordinary skill in the art will be able to select the other additives and concentration based on the industry. By way of example, for a detergent for cleaning clothes, the treatment fluid can further include one or more anionic or non-ionic surfactants, one or more solvents, chelating agents, suspending agents, bleach, de-foaming agents, foaming agents, fragrances, process aids, anti-redeposition agents, and enzymes.

The methods include introducing the treatment fluid into a well, wherein the well penetrates the subterranean formation. The well can be an oil, gas, or water production well, a geothermal well, an improved/enhanced oil recovery or other type of injection well. The well can include a wellbore. The subterranean formation can be part of a reservoir or adjacent to a reservoir. The step of introducing the treatment fluid can be for the purpose of: drilling a wellbore using a drilling fluid treatment; cementing a portion of the wellbore using a cement composition; flushing a drilling fluid from the wellbore prior to introduction of a cement composition using a spacer fluid; or creating fractures within the subterranean formation. The treatment fluid can be in a pumpable state before and during introduction into the well. The treatment fluid can be mixed prior to introduction. The step of mixing can include using a mixing apparatus. The treatment fluid can also be introduced into the well using a pump.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more atoms, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A treatment fluid comprising:
a base fluid; and
a surfactant, wherein the surfactant is a quaternized alkoxylated polyethylene amine produced by:
reacting reactants to form an alkoxylated polyethylene amine, wherein the reactants consist essentially of a polyethylene amine, propylene oxide, and ethylene oxide, wherein the polyethylene amine is first reacted with the propylene oxide and then reacted with the ethylene oxide; and then
reacting the alkoxylated polyethylene amine with a quaternization agent.

2. The treatment fluid according to claim 1, wherein the base fluid comprises water.

3. The treatment fluid according to claim 1, wherein the base fluid comprises a hydrocarbon liquid.

4. The treatment fluid according to claim 3, wherein the hydrocarbon liquid is selected from the group consisting of: a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof.

5. The treatment fluid according to claim 1, wherein the surfactant is a cationic surfactant.

6. The treatment fluid according to claim 1, wherein the polyethylene amine is selected from diethylene triamine, triethylene tetramine, or tetraethylene pentamine.

7. The treatment fluid according to claim 1, wherein the polyethylene amine has a molecular weight in the range of 100 to 10,000.

8. The treatment fluid according to claim 1, wherein the number of nitrogen atoms that are quaternized range from 1 to 5.

9. The treatment fluid according to claim 8, wherein the quaternization agent is selected from compounds comprising methyl-, ethyl-, or benzyl-substituents with Cl⁻, Br⁻, or SO₄⁻² counter-anions.

10. The treatment fluid according to claim 1, wherein the alkoxylated polyethylene amine is in a concentration in the range of 95 to 99.9 weight percent and the quaternization agent is in a concentration in the range of 0.25 to 5 weight percent.

11. The treatment fluid according to claim 1, wherein the surfactant is in a concentration in the range of 0.0001% to 40% by weight of the base fluid.

12. The treatment fluid according to claim 1, wherein the treatment fluid is an oil and gas servicing treatment fluid.

13. The treatment fluid according to claim 12, wherein the treatment fluid further comprises proppant, a viscosifier, cement, a suspending agent, a weighting agent, a friction reducer, a filler, a fluid loss additive, a set retarder, a strength-retrogression additive, a light-weight additive, a defoaming agent, a mechanical property enhancing additive, a lost-circulation material, a filtration-control additive, a thixotropic additive, and combinations thereof.

14. The treatment fluid according to claim 1, wherein the treatment fluid is a laundry detergent, a personal care formulation, an industrial cleaner, a paint or coating, or a mining operation fluid.

15. The treatment fluid according to claim 1, wherein the concentration of the polyethylene amine is in the range from 0.2% to about 10% by weight of the reactants, wherein the concentration of the propylene oxide in the range of 30% to 97% by weight of the reactants, and wherein the concentration of the ethylene oxide in the range of 2.8% to 50% by weight of the reactants.

16. A method of treating a subterranean formation comprising:
introducing a treatment fluid into a well, wherein the well penetrates the subterranean formation, and wherein the treatment fluid comprises:
a base fluid; and
a surfactant, wherein the surfactant is a quaternized alkoxylated polyethylene amine produced by:
reacting reactants to form an alkoxylated polyethylene amine, wherein the reactants consist essentially of a polyethylene amine, propylene oxide, and ethylene oxide, wherein the polyethylene amine is first reacted with the propylene oxide and then reacted with the ethylene oxide; and then reacting the alkoxylated polyethylene amine with a quaternization agent.

17. The method according to claim 16, wherein the treatment fluid is a stimulation fluid.

18. The method according to claim 17, further comprising creating one or more fractures within the subterranean formation during the step of introducing the treatment fluid into the well.

19. The method according to claim 16, wherein the polyethylene amine is selected from diethylene triamine, triethylene tetramine, or tetraethylene pentamine.

20. The method according to claim 16, wherein the quaternization agent is selected from compounds comprising methyl-, ethyl-, or benzyl-substituents with Cl⁻, Br⁻, or SO₄⁻² counter-anions.
